(19) United States
(12) Patent Application Publication
(10) Pub. No.: US 2017/0043357 A1
(43) Pub. Date: Feb. 16, 2017

(54) Continuous Flow Centrifuge For Fluid Separation Or Water Desalination And Purification

(71) Applicant: Karl Lee Sherman, Patton, PA (US)

(72) Inventor: Karl Lee Sherman, Patton, PA (US)

(21) Appl. No.: 15/236,311

(22) Filed: Aug. 12, 2016

Related U.S. Application Data
(60) Provisional application No. 62/205,162, filed on Aug. 14, 2015.

(51) Int. Cl. B04B 5/04; C02F 1/38; B04B 1/04

(52) U.S. Cl. CPC B04B 5/0442; B04B 1/04; C02F 1/38; C02F 2103/08

(57) ABSTRACT

In an embodiment, a continuous flow centrifuge for water desalination comprises a double walled enclosure casing having a water egress and ingress. The centrifuge rotates around a central axis, which a rotor extends through wherein one or more main ball bearings and one or more thrust roller bearings aid in the rotation. Extending from the rotor is a plurality of radial flow chambers terminating in one or more circumferential drain openings allowing for the selective expulsion of fluid. Pluralities of channel divider discs extend from the rotor and are between the radial flow chambers. A fluid outlet is connected to an egress of the centrifuge. A pump impeller is positioned at the egress wherein water is pulled through the ingress.

### CROSS-REFERENCE TO RELATED APPLICATION(S)

The present application claims priority to U.S. Provisional Patent Application No. 62205162 filed on Aug. 14, 2015, entitled “Continuous Flow Centrifuge With The Application Of Water Desalination And Purification” the entire disclosure of which is incorporated by reference herein.

### BACKGROUND OF THE INVENTION

1. Field of Invention

The present invention relates to the field of screen centrifuges as applied to fluid separation, desalination, and purification.

2. Description of Related Art

The science and industrial communities have utilized screen centrifuges for the past century as a means of filtering or dewatering mixtures. As the centrifuge spins, centrifugal forces force large particles to the outer perimeter of the centrifuge. If a screen is placed between an outer collection bowl and an interior centrifuge system, the particles larger than the screen apertures will be held back, allowing liquid to pass through the screen or grate. After spinning for a period of time, the particles will be prevented from passing through the screen or grate and completely dry. Perhaps the simplest and most commonplace example of this is a washing machine.

An additional use for centrifuges is commonly seen in biomedical research and heath laboratories. Blood samples from patients are collected and centrifuged in order to separate whole blood into its various components. This process is known as blood fractionation as it can separate blood plasma, leukocytes, erythrocytes, as well as insoluble proteins. No continuous flow centrifuges are currently used in this application however a need may arise in the future.

Large industrial centrifuges are used by the oil industry in order to remove solids from the drilling fluid. Furthermore, disc-stack centrifuges use extremely high centrifugal forces to separate liquid phases from each other. Disc-stack centrifuges are commonly seen in the oil sands industry where liquids are separated from bituminous sands, which are used to make asphalt. These have the ability to either retain solids at the periphery or continuously discharge the solids from the periphery.

Manually operated, as well as industrial centrifuges are used in the milk industry in order to separate milk into cream and skimmed milk. This works along the same principles described herein as the heavy components are forced to the periphery of the centrifuge and expelled while the lighter cream is near the axis. Described by Gales (770,748) improvements have been made in the technology wherein the liner of the centrifuge is composed of superimposed separated conical disks.

Historically, centrifugation has been a means of extracting precious metals such as gold from a slurry, but it can be applied to any fibrous, amorphous, or crystalline material. It is a method of choice for industry as the unique forces applied by the centrifuge allow for guaranteed separation of materials governed by the laws of physics. This produces a high yield product with relatively low output of energy compared to other means of particle separation. Such as centrifuge is described by Sharples (3630379), wherein a frustoconical screen centrifuge is described. This idea is further described by Knelson (46080040) wherein a plurality of radially extending rings is used.

Utilizing centrifugal forces to desalinate ocean water has been a recent area of focus for many researchers in the environmental industry. Desalination is a natural process occurring via the evaporation of ocean water, which is then condensed in the atmosphere and redistributed as rain. However, as the climate changes, the natural process of fresh water production may not be enough to meet the water demands of a rising population, and artificial means may be used.

To mitigate the risk of a global water shortage, mass desalination efforts are being made to take large amounts of saline water, and turn it into fresh water. Current methods include but are not limited to vacuum distillation, reverse osmosis, and other phase changing protocols such as freezing. Vacuum distillation involves boiling large amounts of ocean water under vacuum to reduce the heat needed for the water to boil. As atmospheric pressure is reduced in the system, the liquid will boil as the vapor pressure equals the ambient atmospheric pressure. The steam produced is condensed in a separate container, resulting in fresh potable water.

A more practical method used by boat owners and outdoorsman is pumping saline water at high pressure through a membrane. This membrane separates any particles from the water using reverse osmosis. Handheld versions of this technology are used by the military, however the final yield is very small and is not practical other than for personal use and survival purposes.

While water purification seems to be a simple theory, the factors present on a molecular level are not as straight forward. Separating non-soluble compounds as mentioned above, is easily accomplished through the use of membranes as well as other gravity-based methods. However, ocean water is a semi-homogenous mixture of salt ions, held together by ionic bonds of the molecules. Separating these ionic bonds requires high forces, presenting challenges.

While the available methods for desalination work well based on sound chemical principles, they consume far too much energy for the relatively low yield produced. This makes the process of water desalination too expensive for most homes or even cities and counties to consider. Reverse osmosis has been rising in popularity, as it does not require a phase change of the water, thus utilizing less energy than methods comprising freezing or boiling. However, pressure systems are utilized in reverse osmosis, increasing the cost of production and necessitating a complex closed system. At a large scale, the process utilizes too much space for the average consumer while producing low yields.

On a community-wide, statewide, or national scale, current desalination technology has not met the economic, output or spatial demands of the consumer. Large offshore desalination plants are currently at work along with onshore treatment facilities. Space needed for these operations is immense in order to accommodate the multitude of structures necessary to complete the process.

Based on the foregoing, there is a need in the art for an energy efficient means of desalinating water, which may be made available to large populations.

### SUMMARY OF THE INVENTION

In an embodiment, a continuous flow centrifuge comprising a double walled enclosure casing having a water ingress and a water egress. The centrifuge has a central axis as well as a plurality of radial flow chambers extending from the central axis. At the periphery of the radial flow chambers, circumferential drain apertures are located to selectively expel fluid and fluid components. A rotor extends through the central axis of the centrifuge and is connected with the entirety of the centrifuge. From the rotor, a plurality of channel divider discs extend outwardly. A fluid outlet may also be connected to the egress of the centrifuge.

In an embodiment, the channel divider discs are each positioned within a radial flow chamber. The channel divider discs may be molded to the rotor allowing for the channel divider discs to rotate along with the rotor.

In an embodiment, the continuous flow centrifuge will have O-ring seals at a plurality of connection within the centrifuge. The O-ring seals prevent the seepage of fluids between connection points of the centrifuge.

In an embodiment, the continuous flow centrifuge will have one or more main ball bearings to aid in the rotation of the centrifuge. In an embodiment, thrust roller bearings may be utilized to further aid in the rotation of the device.

In an embodiment, the continuous flow centrifuge will contain a pump impeller positioned at the egress in order to pull water into the centrifuge. The pump will continuously operate as the centrifuge is able to continuously operate.

In an embodiment, the enclosure casing has a frustoconical shape. The frustoconical shape is able to direct fluids using the centrifugal forces of the centrifuge.

In an embodiment, the circumferential drain openings have an s-shaped curve in order to slow down the fast moving particle in the fluid. In an alternate embodiment, the circumferential drain apertures may contain fibrous material elements for alternate applications of the device. In an alternate embodiment, the radial flow chambers terminate in a pocket designed to selectively expel fluid.

In an embodiment, the centrifuge will comprise a top cover molded to an end of the centrifuge. The top cover will be positioned to impede seepage of fluid in or out of the centrifuge.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a sectional view of the centrifuge assembly, according to an embodiment of the present invention;

FIG. 2 is a plan view of the centrifuge assembly, according to an embodiment of the present invention.

FIG. 3 is a detail view of the contiguous stages of the centrifuge, according to an embodiment of the present invention.

FIG. 4 is a sectional view of the centrifuge assembly, according to an embodiment of the present invention

FIG. 5 is a plan view of the centrifuge assembly, according to an embodiment of the present invention.

FIG. 6 is a detail view of the contiguous stages of the centrifuge, according to an embodiment of the present invention.

FIG. 7 is a flowchart illustrating a method of use, according to an embodiment of the present invention.

### DETAILED DESCRIPTION OF PREFERRED EMBODIMENTS

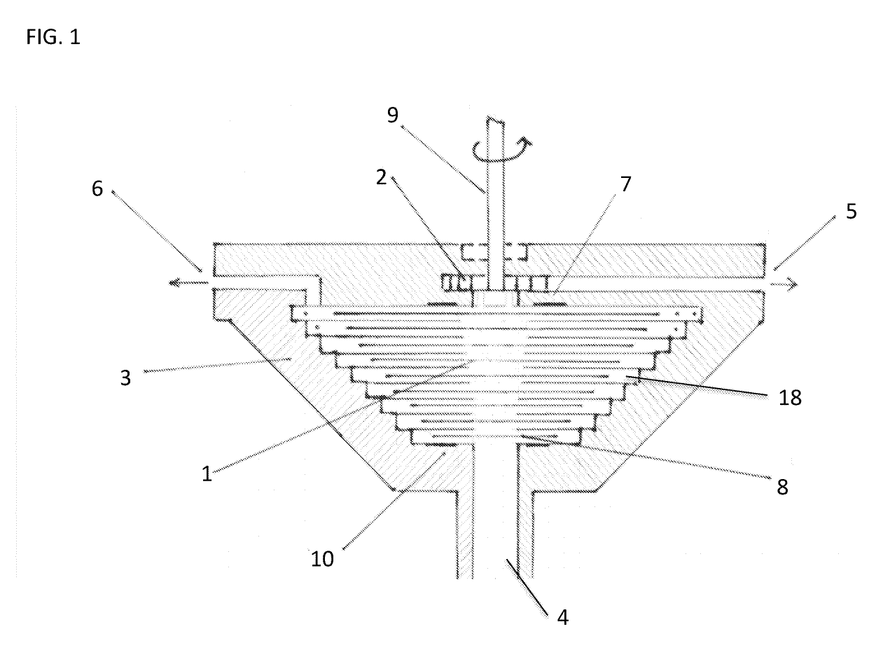

Preferred embodiments of the present invention and their advantages may be understood by referring to FIGS. 1-3, wherein like reference numerals refer to like elements.

With reference to FIG. 1, a continuous flow centrifuge with applications of water desalination and purification is described, wherein a fluid mixture, compound, or solution is input and a preferable compound is emitted. FIG. 1 shows a sectional view of a centrifuge, wherein fluid is driven through an intake opening 4 by a pump impeller 2. In an embodiment, the pump impeller 2 is positioned near the egress of the centrifuge apparatus and spins to draw water through the intake opening 4 at the egress of the centrifuge. The centrifuge is in rotational motion with speed and direction determined by an input shaft 9. In an embodiment, input shaft 9 provides the rotational force for the centrifuge. As fluid moves through the intake opening 4, it enters the primary centrifuge stage 8.

The centrifuge has a plurality of stages, each stage positioned within a radial flow chamber. In an embodiment, radial flow chambers are characterized by containing a central plenum cavities 12, connecting to channel divider discs 20. The channel divider discs 20 extended axially to the periphery of the centrifuge. As fluid is transmitted to each stage of the centrifuge, the fluid strikes the channel divider disc 20 and is acted upon by centrifugal forces, forcing the fluid to the periphery. Fluid travels axially along the radial flow chambers, exiting the apertures and re-entering the flow chambers where the fluid is forced back to the central axis of the centrifuge. As fluid enters the central plenum area once more, the process repeats. The perimeter of each radial flow chamber contains at least an aperture. The aperture allows for the expulsion of fluid and heavy contaminants. As fluid re-enters the radial flow chamber, the heavy contaminants remain at the periphery.

Once at the periphery of the circumferential drain apertures, dense materials may collect on the centrifuges enclosure casing resulting in a brine-like substance. In a preferred embodiment, high centrifugal forces extract the heavy salt ions from the water along with other contaminants. Water or other desirable fluids will reenter the primary centrifuge stage 8 and will be forced laterally into a plurality of centrifuge stages, each of which containing circumferential drain apertures 15. The frustoconical construction of the centrifuge results in an increased circumference with each additional stage of centrifugation. This design allows fluids to continue laterally through the plurality of centrifuge stages. In an embodiment, the centrifugal forces of the primary centrifuge stage 8, accelerates liquid to the perimeter of the rotating centrifuge through radial flow chambers 18. Increasing centrifugal forces derived from the circular motion of the centrifuge accelerates fluid to the periphery of the system. The centrifuge's inherent ability to produce centrifugal forces on any component connected or rotating around the central rotor forces water to the perimeter wherein heavier water having contaminants therein moves to the perimeter in a proportionally greater amount. Pluralities of radial flow chambers 18 are interconnected extending axially with reference to the centrifugal force vector.

The ability of the more radial flow chambers to be stacked upon results in the ability of the centrifuge to have a degree of scalability. In a preferred embodiment, the centrifuge is designed with nine stages. Embodiments may contain varying numbers of centrifuge stages based on the application of the centrifuge.

As centrifugal and thus gravitational forces increase towards the periphery of the rotor, denser material aggregates and are selectively expelled through circumferential drain apertures 15. In an embodiment, circumferential drain apertures 15 act by slowing the acceleration of saline water. While heavier ions and contaminants will experience a greater force.

In an embodiment of the design, the brine is expelled at high pressure through the circumferential drain apertures 15, forcing the brine material to exit the enclosure through an expulsion outlet 6. The expulsion outlet 6 is located at the terminal end where the maximum circumference is present in the centrifuge casing. As the desirable fluid moves through the increasing centrifuge stages, the fluid passes through the pump impeller 2 and is ejected through the fresh water outlet 5 located at the terminal end of the centrifuge where the maximum circumference is present. In an embodiment, a plurality of O-ring seal structures 7, 10, mounted in the enclosure cover and base, prevent desirable fluid in the centrifuge from mixing with the brine.

In an embodiment, fluids may be extracted from the centrifuge by other methods known in the art, such as vacuum suction. Fluids may be collected in any manner deemed useful.

In an alternate embodiment, the outlet port 5 and expulsion outlet may be functionally reversed to suit changing extraction needs. Switching the collection and expulsion methods of the device allows for the extraction of solvents, collection of minerals and heavy metals, or purification of compounds. Other embodiments of the design will be apparent to those skilled in the art.

In an embodiment, a pre-filtration mechanism may be attached prior to the intake opening. A pre-filtration may describe, but is not limited to membrane filtration, magnetic filtration, as well as others known in the art.

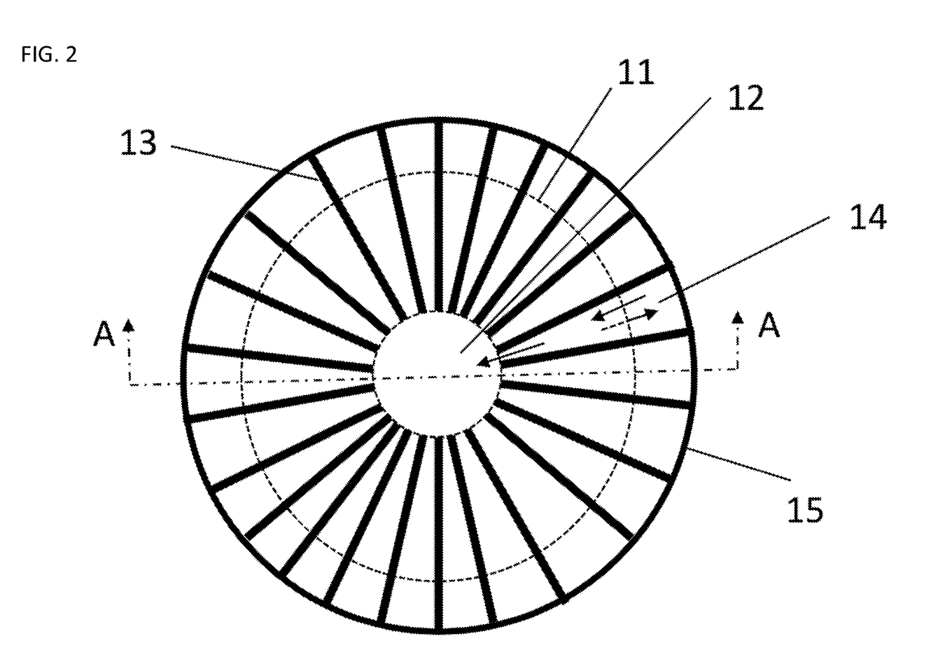

With reference to FIG. 2, a vertical view of the centrifuge body is shown. In a preferred embodiment, this centrifuge body contains a plurality of radial partially divided channels 11. These radial divided channels are infinitely scalable in a perpendicular direction with reference to the centrifugal force vector. As fluid is forced towards the circumference of the centrifuge by increasing gravitational forces, the return flow of the fluid forces preceding fluids laterally into the central plenum cavities 12 where the fluid will enter the next centrifuge stage. A plurality of channel divider discs 20 are constructed between the central plenum cavities 12. As fluid contact the plurality of channel divider disc 20 in each respective centrifuge stage, the fluid will be forced laterally by the centrifugal force.

Sector walls 13 extend in a radial manner from the central plenum cavities forcing fluids through the centrifuge stages. As fluids and undesirable matter flow through circumferential drain apertures 15, circumferential and central flows 14 are created exchanging undesirable matter for fluids with increasing levels of purity.

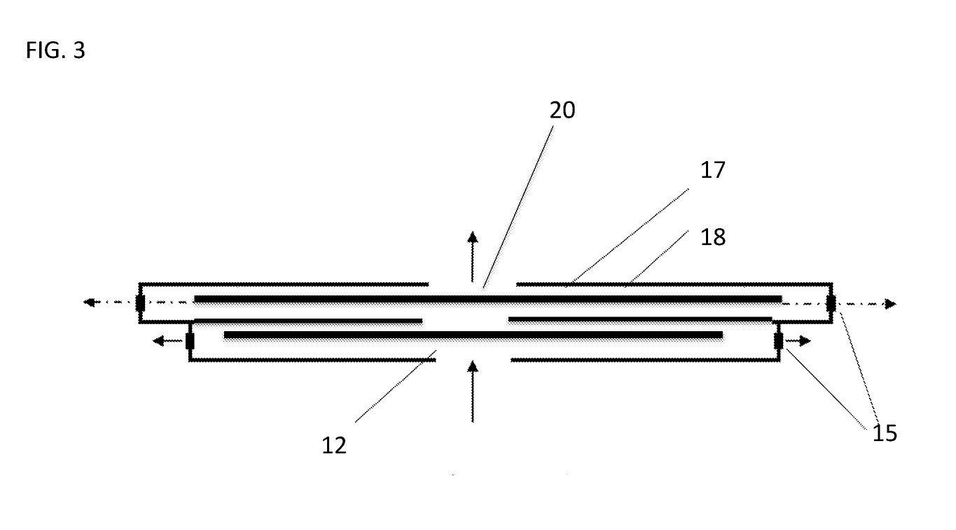

With reference to FIG. 3, a sectional view of contiguous stages of the centrifuge is shown. As liquid moves laterally through the central plenum cavities resulting in a central columnar flow, impact with the channel divider disc 20 will force liquid to move transverse to the axis of rotation toward the perimeter of the centrifuge along the radial flow chamber 18 where increasing gravitational forces ensue.

As fluids continue laterally through each stage of the centrifuge, gravitational and centrifugal forces increase in sequence with each additional stage of the centrifuges frustoconical structure. In a preferred embodiment, each centrifuge stage will house circumferential drain apertures 15 at the perimeter in order to continually facilitate the purification of fluids. Furthermore, each centrifuge stage will contain a radial flow chamber 18 separated in part by a channel divider disc 20, with an upper radial flow chamber defined as the channel divider disc 20 and upper radial flow chamber 17.

In an embodiment, a plurality of circumferential drain apertures are characterized by a curved aperture such as an s-shaped curve leading to the enclosure casing 3 where brine is collected. This s-shaped curve will slow the eluted particles such as salt ions or other impurities before they impact the enclosure wall 3. At high centrifuge speeds, the force if impurities impacting the enclosure wall may result in malfunction of the centrifuge. For this reason, a buffer, or redirection of acceleration of the particles between the radial flow chamber and enclosure casing 3 may be desired.

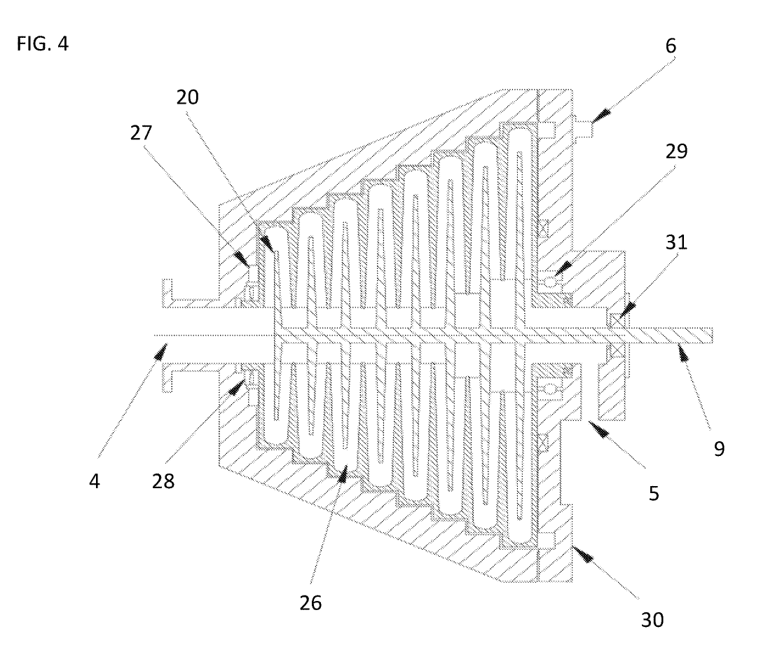

With reference to FIG. 4, an embodiment of the continuous flow centrifuge is described. In an embodiment, the centrifuge may be adjusted so that the axis of rotation extends horizontally, as seen effective in varying applications. Pluralities of O-ring seals 27 are placed throughout the design of the centrifuge as needed in order to keep the brine or heavy fluids from entering the centrifuge stages after expulsion through the circumferential drain apertures 15. The O-ring seals 27 may be necessary at any joining of materials separating the brine from the desirable fluids throughout the centrifuge.

In an embodiment, and in addition to the O-ring seals 27, an input shaft seal 31 is included to prevent seepage of fluids around the rotor 9. It is important for the O-ring structures as well as the input shaft seal to ensure fluids stay in the specific compartment of the centrifuge as well as maintaining heat energy, or pressure in embodiments of the design. To help further seal the structure, a top cover 30 for the enclosure casing 3 of the centrifuge functions in conjunction with the O-ring seals 27 in order to keep the centrifuge sealed both within the centrifuge stages as well as sealing the centrifuge from the outside environment. As previously mentioned, this brings increasing importance as heating, cooling, pressurization, and gaseous methods are introduced in alternative embodiments.

In an embodiment, a thrust roller bearing 28 is placed near the intake opening 4 in order to aid in the circular motion of the centrifuge. Furthermore, a main ball bearing 29 which supports the rotating structure of the centrifuge. The main ball-bearing 29 may be constructed from a plurality of material and techniques known in the art, however, it is necessary that the bearing is able to endure high centrifuge speeds necessary for desalination and other applications.

In an embodiment, the fluid expulsion outlet 6 may be molded to the top cover. The position of the fluid expulsion outlet 6 may vary depending on centrifuge structure, orientation, application, or operational procedure.

In an embodiment, the central axis of the centrifuge is horizontally orientated. Orientation of the centrifuge may be fixed or adjustable based on application.

In an embodiment, fluid may be pretreated may be pretreated by numerous methods known in the art such as, but not limited to, membrane filtration. In an embodiment, fluid may be deaerated in order to remove air bubble present in the fluid which may disturb the functional balance of the centrifuge. This method is useful as the centrifuge approaches high speeds necessary to separate salt ions from water.

Centrifuge velocity resultant upon a force in excess of 20,000 to 50,000 times the force of gravity may be necessary to separate the salt ions. In an embodiment, the centrifuge is capable of refrigeration, heat induction, gaseous induction, chemical induction, magnetic ion dehydration, as well as other means known in the art in order to reduce the forces necessary to separate the ions.

In an embodiment, radial flow chambers 18 terminate in pockets 26 where fluids are collected based on the centrifugal forces present as pressure builds. The pockets 26 selectively expel fluid through the circumferential drain apertures 15.

In an embodiment, the centrifuge design may be cylindrical or any other shape known in the art. An alternate design may be favorable for alternate applications and space requirements. In an embodiment, the centrifuge stages may be equal in diameter.

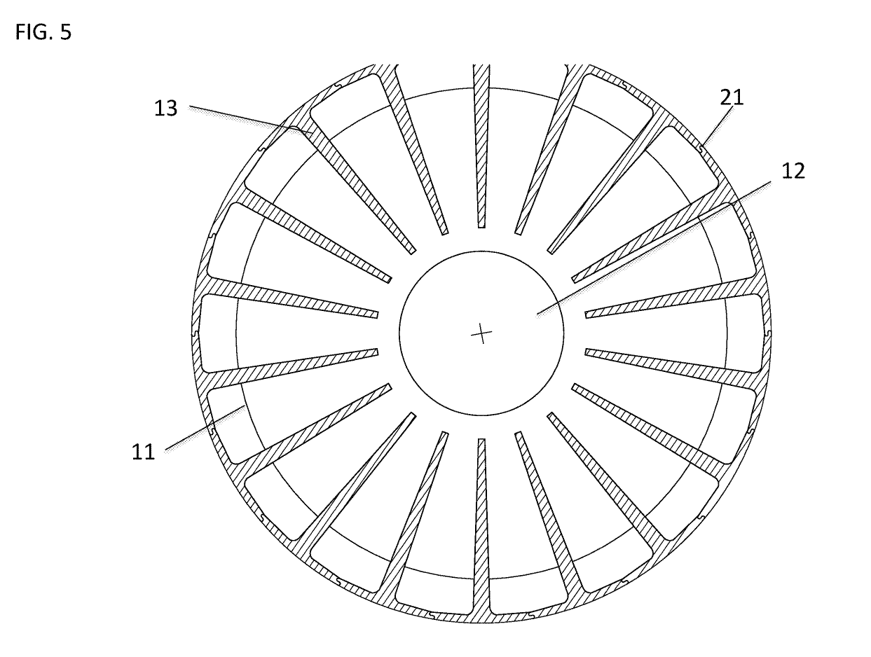

With reference to FIG. 5, an embodiment of the design is described. In an embodiment of the present invention, s-shaped circumferential drain apertures 21 may be molded to one or more radial flow chambers. With the immense forces emitted by molecules striking the enclosure casing 3 it is useful to manufacture the design with apertures that function to slow the speed of molecules as well as the fluid exiting the circumferential drain apertures 15. While the present embodiment indicates an s-shaped design, it is apparent to one in the art that other embodiments pertaining to the design of the circumferential drain apertures may be modified.

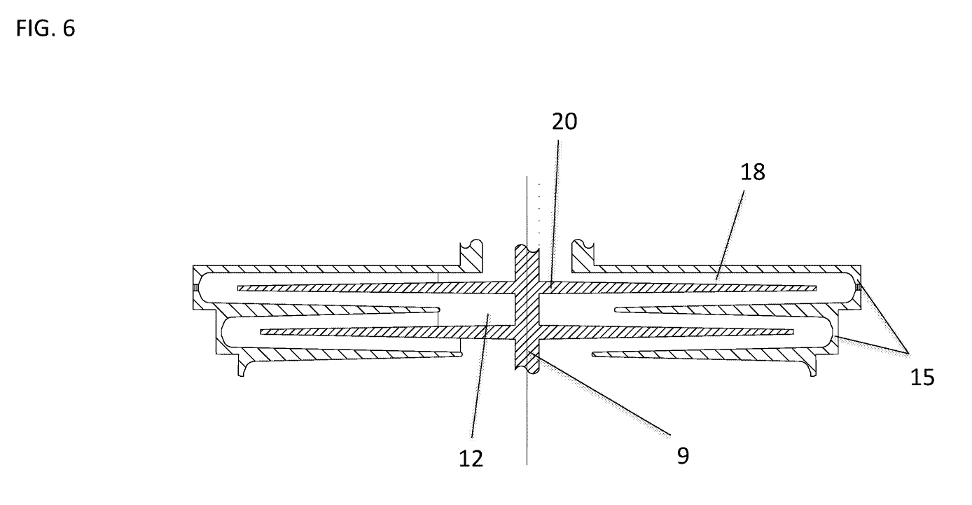

With reference to FIG. 6, an embodiment of the continuous flow stages is described. An embodiment depicts the channel divider discs 20 integrally molded to the rotor 9 of the centrifuge. An integrally molded design allows for a simpler production protocol, reducing manufacturing costs and lowering the maintenance risk. In an embodiment, the centrifuge may be produced by 3D printing technology, or other manufacturing methods known in the art.

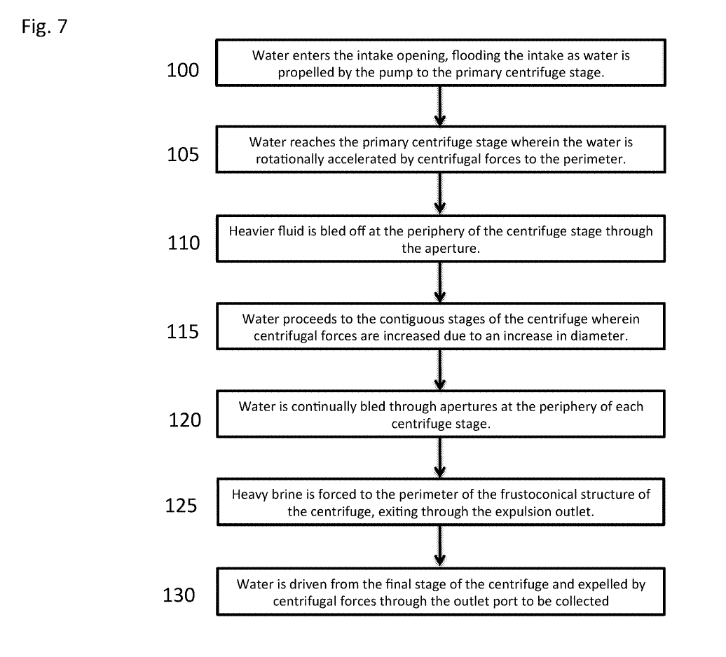

Referencing FIG. 7, a method is described in an embodiment of the device. In Step 100, water enters the inlet. As the inlet is flooded, water is drawn in by the pump impeller towards the subsequent stages of the design. In step 105, the water reaches the first stage wherein it is rotationally accelerated by the rotational force exerted by the rotor. As fluid accelerates to the periphery of the device in the primary centrifuge stage 8 within the radial flow chamber 18, centrifugal forces continue to increase. In step 110 the heavier fluid is bled off at the periphery through the aperture. In step 115 the water proceeds to the next stage, wherein, due to the wider diameter of this second stage, the rotational velocity is higher resulting in higher centrifugal force at the periphery, which is then bled into the apertures. At step 120, water continues through the remaining stages of the centrifuge as contaminants are expelled through the apertures. In step 125, heavy brine is forced to the perimeter of the frustoconical structure of the centrifuge, where it may exit through an expulsion outlet 6. In an embodiment, brine may be collected and compounds present may be further extracted, purified, crystalized, or subject to other methods known in the art. In step 130, water is driven from the final stage of the centrifuge and expelled by centrifugal forces through the outlet port 5 where it may be collected.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A continuous flow centrifuge comprising:
a. a double-walled enclosure casing having a water ingress, a water egress and central axis, and defining a plurality of radial flow chambers;
b. one or more circumferential drain apertures positioned at the outer circumference of the radial flow chambers;
c. a rotor extending through the central axis of the centrifuge connected to the centrifuge;
d. a plurality of channel divider discs extending outwardly from the rotor;
e. a fluid outlet connected to an egress of the centrifuge.

2. The continuous flow centrifuge of claim 1, wherein the channel divider discs are each positioned within a radial flow chamber, and are adapted to rotate around the axis within the radial flow chambers.

3. The continuous flow centrifuge of claim 1 further comprising one or more O-ring seals at a plurality of connections within the centrifuge.

4. The continuous flow centrifuge of claim 1 further comprising one or more main ball bearings integrated to support the centrifuge and aid in rotation of the centrifuge.

5. The continuous flow centrifuge of claim 1 further comprising one or more thrust roller bearings to further aid in the rotation of the device.

6. The centrifuge of claim 1 further comprising a pump impeller positioned at the egress to pull water into the centrifuge.

7. The centrifuge of claim 5 wherein the enclosure casing is frustoconically shaped and molded encompassing the plurality of centrifuge stages.

8. The centrifuge of claim 5 wherein the circumferential drain apertures comprise a membrane.

9. The centrifuge of claim 5 wherein the radial flow chambers terminate in a pocket designed to selectively expel fluid through the circumferential drain apertures.

10. The centrifuge of claim 5 wherein the plurality of radial flow chambers terminate in an s-shape aperture.

11. The centrifuge of claim 5 further comprising a top cover molded to an end of the centrifuge, positioned to impede seepage of fluid in or out of the centrifuge.

12. A method of using a centrifuge, comprising the steps of:
a. water entering the inlet;
b. water being drawn in by the pump impeller;
c. water reaching the first stage wherein it is rotationally accelerated by the rotational force exerted by rotor;
d. bleeding off the heavier fluid through one or more aperture;
e. the water proceeding to a second stage, wherein, due to the wider diameter of this second stage, the rotational velocity is higher resulting in higher centrifugal force at the periphery, which is then bled into the apertures;
f. the water continuing through the remaining stages of the centrifuge as contaminants are expelled through the apertures;
g. forcing the heavy brine through an expulsion outlet; and
h. collecting remaining water at an outlet port.
